(19) United States
(12) Patent Application Publication
(10) Pub. No.: US 2010/0276457 A1
(43) Pub. Date: Nov. 4, 2010

(54) PROTECTION HOOD FOR A FLUID PRODUCT DISPENSING HEAD

(75) Inventors: Ludovic Petit, Vitot (FR); Xavier Pottier, Saint Samson De La Roque (FR)

Correspondence Address: SUGHRUE MION, PLLC, 2100 PENNSYLVANIA AVENUE, N.W., SUITE 800, WASHINGTON, DC, 20037, US

(73) Assignee: Valois SAS, Le Neubourg (FR)

(21) Appl. No.: 12/600,942

(22) PCT Filed: May 19, 2008
(86) PCT No.: PCT/FR2008/050863

§ 371 Date: Nov. 19, 2009

(30) Foreign Application Priority Data
May 22, 2007 (FR) 07 55198

(51) Int. Cl. B67D 7/06

(52) U.S. Cl. 222/321.6; 222/562

(57) ABSTRACT

A protective cap for covering, in a closed position, a dispenser head (4) of a fluid dispenser, said head including an end wall (40) incorporating a dispenser orifice (401), and a lateral wall (42), said cap including, on its inside, at least one sealing profile (500, 520) that, in the closed position, co-operates in leaktight manner with the lateral wall (42) of the head (4), in the proximity of said dispenser orifice.

The present invention relates to a protective cap for a dispenser head of a fluid dispenser, in particular of the nasal-spray type, and such a dispenser head and a fluid dispenser including such a protective cap.

In the prior art, it is known to use a removable cap for closing the dispenser orifice of such a dispenser. Such caps are described in particular in documents WO 00/61454 and WO 98/00354.

While it is in its closed position, that type of removable cap closes the dispenser orifice in leaktight manner by means of a closure element that is fastened to the inside of the top wall of the cap. The closure element could be a deformable pad or an elastomer stopper of material that differs from the cap, and that is fastened to the inside of the top wall of the cap. Closure by means of the pad or the stopper occurs directly at, or inside, the orifice, thereby guaranteeing good sealing. However, after several successive uses of the dispenser, there exists a risk of that type of elastomer stopper or pad being irreversibly deformed, thereby leading to unreliable sealing. In addition, the dimensions of the closure element need to be adapted specifically to each type of dispenser orifice. The cap itself must be adapted specifically to the dimensions of the dispenser head, and its manufacture thus requires accurate control over dimensions so as to obtain perfectly leaktight co-operation between the closure element and the orifice. In particular, if the closure member is not dimensioned suitably, fluid can evaporate, with the risk of an incomplete dose being dispensed during the next actuation. Fluid can also dry out inside the dispenser head, possibly blocking the orifice and making it difficult, or even impossible, for fluid to be dispensed. In other circumstances, putting the cap into place on the head can turn out to be difficult, or even impossible, if the dimensions do not fit accurately.

Documents EP-0 131 501, WO 2007/009872, and EP-0 775 530 describe other prior-art devices including protective caps, each of which is merely engaged in removable manner on the dispenser head at its bottom edge.

An object of the present invention is to provide a protective cap that does not present the above-mentioned drawbacks.

In particular, an object of the present invention is to provide a protective cap that guarantees better sealing, with improved life-time for the dispenser device.

Another object of the present invention is to provide a protective cap that is simple and inexpensive to manufacture and to assemble.

Another object of the present invention is to provide a protective cap that can be adapted easily to the dispenser heads of existing dispensers, and that does not require any modification of the dispenser head, offering better dimensional compensation.

The present invention thus provides a protective cap for covering, in a closed position, a dispenser head of a fluid dispenser, said head including an end wall incorporating a dispenser orifice, and a lateral wall, said cap including, on its inside, at least one sealing profile that, in the closed position, co-operates in leaktight manner with the lateral wall of the head, in the proximity of said dispenser orifice.

Advantageously, said at least one sealing profile projects from a top and/or lateral inside wall of the cap.

Advantageously, in the closed position, said at least one sealing profile is deformed and/or compressed in leaktight manner against the dispenser head.

Advantageously, said at least one sealing profile comprises at least one: lip and/or bead and/or tab and/or flange and/or ring.

Advantageously, it is made as a single piece.

Advantageously, a lateral wall of the cap is conically shaped at least in part.

Advantageously, it is made of a plastics material that is substantially rigid.

Advantageously, it includes fastener means for holding it in stationary manner on the dispenser head.

The present invention also provides a dispenser head of a fluid dispenser, said dispenser head being characterized in that it includes a cap as described above.

Advantageously, the dispenser head includes a nasal-spray actuator including an axial central dispenser orifice made in the end wall of said dispenser head, said cap being made in the form of a hollow sleeve that is fastened around said nasal-spray actuator, said cap including an annular sealing profile that projects from its lateral inside wall and that co-operates in leaktight manner with the lateral wall of the dispenser head in the closed position.

Advantageously, the dispenser head includes a nasal-spray actuator including an axial central dispenser orifice made in the end wall of said dispenser head, said cap being made in the form of a hollow sleeve that is fastened around said nasal-spray actuator, said cap including an annular sealing profile that projects from the inside of the top wall and that co-operates in leaktight manner with the lateral wall of the dispenser head in the closed position.

The present invention also provides a fluid dispenser comprising a fluid reservoir and a dispenser member such as a pump or a valve, said fluid dispenser being characterized in that it includes a dispenser head as described above.

Other characteristics and advantages of the present invention appear from the following detailed description of two advantageous embodiments of the invention, given by way of non-limiting example, and with reference to the accompanying drawings, in which:

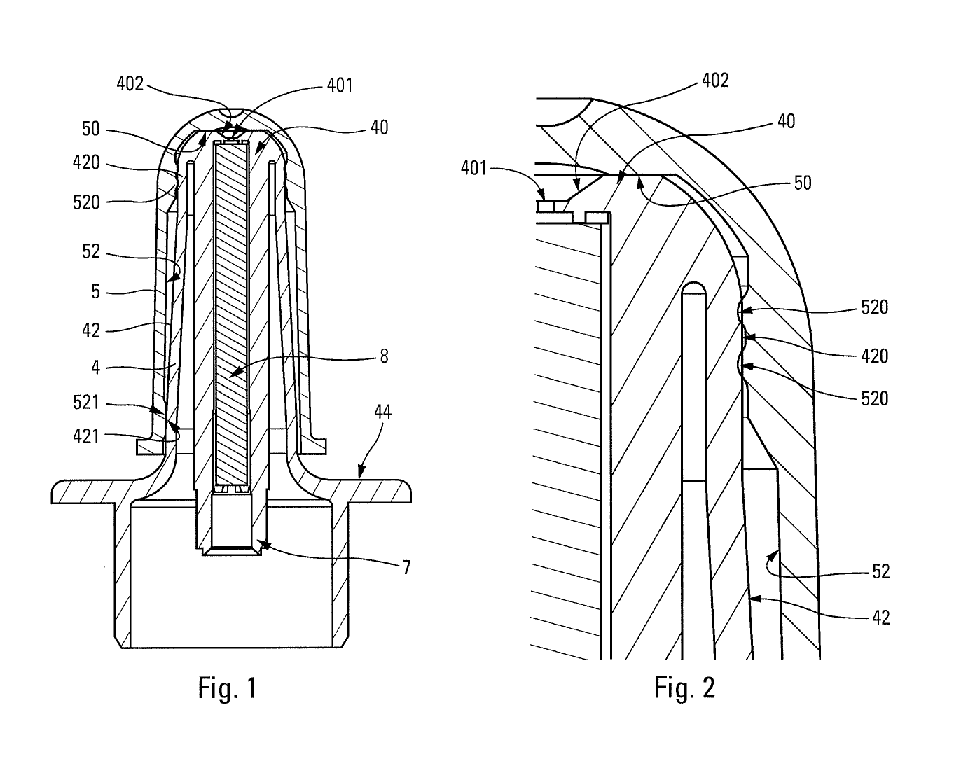

FIG. 1 is a diagrammatic longitudinal section view of a protective cap constituting a first embodiment of the invention, in its closed position on a nasal dispenser head;

FIG. 2 is a large-scale fragmentary view of the FIG. 1 cap;

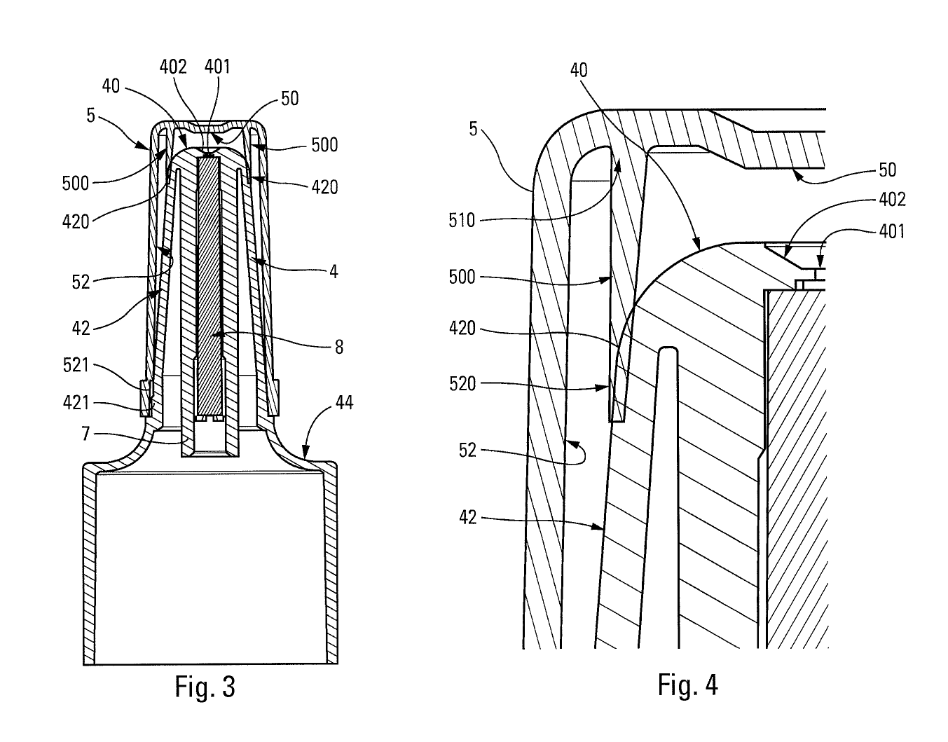

FIG. 3 is a diagrammatic longitudinal section view of a protective cap constituting a second embodiment of the invention, in its closed position on a nasal dispenser head; and

FIG. 4 is a large-scale fragmentary view of the FIG. 3 cap.

The present invention relates to a protective cap and to a dispenser head and a fluid dispenser including such a protective cap. Since the protective cap of the invention can be applied to any type of dispenser, the dispenser is not described in detail below.

FIGS. 1 to 4 diagrammatically show a protective cap 5 of the invention, covering a dispenser head 4 that advantageously has the shape of a nasal-spray actuator that is adapted to spray a fluid into a nostril. Naturally, the cap 5 of the invention is not limited to protecting that type of actuator. In fact, the cap of the invention can be applied to any type of dispenser head that includes a dispenser orifice for dispensing fluid that is likely to evaporate and/or dry out and/or block the dispenser orifice.

With reference to FIGS. 1 and 3, the actuator 4 includes an axial dispenser orifice 401 in its axial end wall 40. At its opposite end, a bearing surface 44 for actuating the dispenser can be provided, together with connection means 7 for connecting the head 4 to a dispenser member, such as a pump or a valve (not shown). Other variants are also possible depending on the type of dispenser used. Advantageously, in the expulsion channel leading to the orifice 401, the head includes an internal nozzle or an insert 8 for limiting the dead volume and for creating a spray through the orifice 401. The dispenser head thus presents an end wall 40 that incorporates the dispenser orifice 401, and a lateral wall 42. The lateral wall 42 may itself include a lateral border wall 420 that is situated in the proximity of the end wall 40, and a lateral base wall 421 that is situated at the base of the actuator, in the proximity of the bearing surface 44.

A removable protective cap 5 is shown in its closed position in the figures, in the form of a hollow sleeve. The cap includes a lateral inside wall 52 and a top wall 50 at its axially top end. In advantageous manner, the cap of the invention may include a lateral wall 52 that is conically shaped at least in part, and thus particularly well suited to different types of actuator. Although the cap 5 is made in the form of an elongate hollow sleeve in this embodiment, it could naturally have any other appropriate shape.

As shown in FIGS. 1 and 3, the cap can also include fastener means 521 on its lateral wall 52, so as to hold said cap securely in its closed position on the dispenser head 4. The fastener means for fastening the cap on the head 4 may have any appropriate shape. For example, the cap may be fastened by snap-fastening or it may be screw-fastened on a thread provided on the actuator. The cap may be fastened on the head 4 or to another element of the dispenser, e.g. such as a fastener ring or the fluid container (not shown). The fastener means 521 of the two above-described embodiments may co-operate with the actuator 4 at its lateral base wall 421, as can be seen in FIGS. 1 and 3.

In its closed position, the cap seals the dispenser orifice 401. To do this, the cap of the invention includes at least one sealing profile 500, 520 that projects from one of its inside walls, in the proximity of said dispenser orifice. The profile is advantageously made integrally with the cap, e.g. while said cap is being molded, thereby enabling said at least one sealing profile to have any shape. Advantageously, the cap of the invention is formed as a single piece, preferably made of a plastics material that is substantially rigid, that makes it possible both to co-operate with the head in leaktight manner, and to be manipulated by the user in easy, reliable manner, and without risk.

In a first embodiment, shown in FIGS. 1 and 2, the inside of the cap includes at least one sealing profile 520 that projects from a lateral inside wall 52. Said at least one sealing profile 520 is positioned so that, in the closed position, it co-operates in leaktight manner with the head, at its lateral border wall 420, not far from the dispenser orifice 401.

With reference to FIG. 2 that shows a large-scale detail of FIG. 1, the sealing profile is in the form of two annular sealing beads 520 that project from the lateral inside wall 52 of the cap 5. It is clear that the sealing profile could comprise a single annular bead instead of two. In advantageous manner, the cap includes several other sealing beads so as to guarantee good sealing of the device. In the closed position, the sealing beads 520 are deformed and/or compressed in leaktight manner against the lateral border wall 420 of the dispenser head, which wall is situated towards the top end of the actuator, close to the orifice. Naturally, the sealing profile, represented by two annular beads in FIGS. 1 and 2, could be replaced by, or could further include, at least one: lip, tab, flange, ring, or any other shape; projecting from an inside wall of the cap, and capable, in the closed position, of co-operating in leaktight manner with the lateral border wall 420 of the actuator 4.

With reference to FIG. 2, it can be seen that the dispenser orifice 401 of the nasal-spray actuator 4 is formed at the bottom of a kind of dish 402 that is provided in the end wall of the head 4. This embodiment corresponds to a typical nasal dispenser head. While closing, the cap is engaged around the nasal-spray actuator until the inside of its top wall 50 comes to bear against the end wall 40 of the head 4, in so far as the respective dimensions of the cap 5 and of the head 4 make this possible, as in FIGS. 1 and 2. However, alternatively, the inside of the top wall 50 need not come into contact with the end wall 40 of the head when the sealing profile 520 co-operates in leaktight manner with the lateral border wall 420 of the head in the closed position.

In the closed position of the cap, a small volume of air is held captive and interposed between the end wall 40 of the head, the top wall 50 of the cap, and the annular bead 520. The volume of air held captive is small enough to prevent the fluid from evaporating and/or drying out inside the orifice 401. However, since there is not a closure element that needs to co-operate directly with the dispenser orifice 401, the cap of the invention makes it easier to compensate for dimensional tolerances by creating a volume of air that is greater or smaller as a function of said dimensional tolerances. Since sealing is provided on the side of the head, there is no longer any obligation to provide a cap that fits the head very accurately, and manufacture of the cap consequently becomes simpler and less expensive.

FIGS. 3 and 4 show a second embodiment of the invention in which the sealing profile of the cap is different. The other elements, corresponding to the same numerical references as in FIGS. 1 and 2, are therefore not described again.

With reference to FIGS. 3 and 4, the cap 5 includes a sealing profile in the form of an annular sealing flange or sleeve 500 that projects from the inside of its top wall 50, and that co-operates in leaktight manner with the lateral border wall 420 of the head 4 in the closed position. Advantageously, the annular flange 500 is made integrally with the cap and may present thickness that decreases going away from the inside of the top wall 50 of the cap. With reference to FIG. 4 that shows a large-scale detail of FIG. 3, the flange 500 is thicker at its base 510 than at its free end 520. The shape of the annular flange enables both substantial solidity and strength at its base 510, and substantial flexibility and sealing capacity at its free end 520. While the cap is being closed, the free end 520 of the annular sealing flange 500 is engaged around the axial end of the actuator. The annular flange comes to co-operate in leaktight manner with the lateral border wall 420 of the head 4. In this second embodiment, the inside of the top wall of the cap 50 does not come to bear against the end wall 40 of the head 4. Only the flange 500 comes to bear in leaktight manner against the lateral border 420 of the head. Fastener means 521, similar to the fastener means of the first embodiment, may also be provided for fastening the cap to the head.

As in the first embodiment, in the closed position, it is possible for only a small volume of air to be interposed between the end wall 40 of the head and the top wall 50 of the cap, inside the annular flange. The space available for the volume of air held captive in the closed position is small enough to prevent any fluid from evaporating and/or drying out inside the orifice.

The present invention thus provides a protective cap for protecting, in leaktight manner, the dispenser orifice of a fluid dispenser, which cap is easy to put into place and to remove, guarantees sealing of the orifice in the closed position, even after many uses, and simultaneously prevents any fluid from evaporating or drying out in said dispenser orifice in the closed position.

The present invention is described above with reference to two advantageous embodiments thereof, but it is clear that it is not limited to said embodiments.

In particular, the cap may be of any shape, and the sealing profile(s) may be of any shape, position, and number. In addition, the sealing profile(s) are not necessarily made integrally with the cap, but could be molded on or the like, for example.

Other modifications could be applied by a person skilled in the art, without going beyond the ambit of the present invention, as defined by the accompanying claims.

1. A protective cap for covering, in a closed position, a dispenser head of a fluid dispenser, said head including an end wall incorporating a dispenser orifice, and a lateral wall, said cap being characterized in that, on its inside, it includes at least one sealing profile that, in the closed position, co-operates in leaktight manner with the lateral wall of the head, in the proximity of said dispenser orifice.

2. A cap according to claim 1, wherein said at least one sealing profile projects from a top and/or lateral inside wall of the cap.

3. A cap according to claim 1, wherein, in the closed position, said at least one sealing profile is deformed and/or compressed in leaktight manner against the dispenser head.

4. A cap according to claim 1, wherein said at least one sealing profile comprises at least one: lip and/or bead and/or tab and/or flange and/or ring.

5. A cap according to claim 1, characterized in that it is made as a single piece.

6. A cap according to claim 1, wherein a lateral wall of the cap is conically shaped at least in part.

7. A cap according to claim 1, characterized in that it is made of a plastics material that is substantially rigid.

8. A cap according to claim 1, characterized in that it includes fastener means for holding it in stationary manner on the dispenser head.

9. A dispenser head of a fluid dispenser, said dispenser head being characterized in that it includes a cap according to claim 1.

10. A dispenser head according to claim 9, including a nasal-spray actuator including an axial central dispenser orifice made in the end wall of said dispenser head, said cap being made in the form of a hollow sleeve that is fastened around said nasal-spray actuator, said cap including an annular sealing profile that projects from its lateral inside wall and that co-operates in leaktight manner with the lateral wall of the dispenser head in the closed position.

11. A dispenser head according to claim 10, including a nasal-spray actuator including an axial central dispenser orifice made in the end wall of said dispenser head, said cap being made in the form of a hollow sleeve that is fastened around said nasal-spray actuator, said cap including an annular sealing profile that projects from the inside of its top wall and that co-operates in leaktight manner with the lateral wall of the dispenser head in the closed position.

12. A fluid dispenser comprising a fluid reservoir and a dispenser member such as a pump or a valve, said fluid dispenser being characterized in that it includes a dispenser head according to claim 9.
